(19) United States
(12) Patent Application Publication
(10) Pub. No.: US 2026/0149928 A1
(43) Pub. Date: May 28, 2026

(54) SUSPENSION SYSTEM FOR LOUDSPEAKER

(71) Applicant: Sonos, Inc., Goleta, CA (US)

(72) Inventors: Naphur van Apeldoorn, Amsterdam (NL); Lars Wouterse, Delft (NL)

(21) Appl. No.: 19/114,657

(22) PCT Filed: Sep. 22, 2023
(86) PCT No.: PCT/US2023/074844

§ 371 Date: Mar. 24, 2025

Related U.S. Application Data
(60) Provisional application No. 63/377,652, filed on Sep. 29, 2022.
(60) Provisional application No. 63/503,389, filed on May 19, 2023.

(51) Int. Cl. H04R 7/02

(52) U.S. Cl. CPC H04R 7/02

(57) ABSTRACT

Suspension systems for loudspeakers are disclosed. A loudspeaker can include a frame, a diaphragm flexibly attached to the frame, and a motor for driving the diaphragm. The motor can include a magnetic element and a voice coil. The loudspeaker can additionally include a suspension system with a coil holder coupled to the voice coil, a flat spring coupling the coil holder and the frame, and a compensating element associated with the flat spring.

### CROSS-REFERENCE TO RELATED APPLICATIONS

This application claims the benefit of priority to U.S. patent application Ser. No. 63/377,652, filed Sep. 29, 2022, and to U.S. patent application Ser. No. 63/503,389, filed May 19, 2023, each of which is incorporated herein by reference in its entirety.

### FIELD OF THE DISCLOSURE

The present disclosure is related to consumer goods and, more particularly, to methods, systems, products, features, services, and other elements directed to suspension systems for use in loudspeakers and to loudspeakers or some aspect thereof.

### BACKGROUND

Suspension systems in loudspeakers such as spiders may comprise a ring of rubberized material with corrugations to provide a spring-like suspension effect between a speaker diaphragm and frame or basket. Such systems may be unsuitable when the design of a loudspeaker is varied.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1 is a perspective view of a portion of a loudspeaker.

FIG. 2 is a perspective view of a first suspension system for use in a loudspeaker.

FIG. 3 is another perspective view of the first suspension system of FIG. 2.

FIG. 4 is a further perspective view of the first suspension system of FIG. 2.

FIG. 5 is a perspective view of the first suspension system of FIG. 2 and a voice coil.

FIG. 6 is a plan view showing two suspension systems of FIG. 2 connected by a connecting element.

FIG. 7 is a plan view of a suspension system including stiffening members for use in assembly.

FIG. 8 is a perspective view of a second suspension system and voice coil for use in a loudspeaker.

FIG. 9 is a plan view of the second suspension system and voice coil of FIG. 8.

FIG. 10 is a plan view of a third suspension system for use in a loudspeaker.

FIG. 11 is a perspective view of a fourth suspension system for use in a loudspeaker.

FIG. 12 is a perspective view of a frame for a loudspeaker with two fifth suspension systems.

FIG. 13 is a perspective view of a sixth suspension system for use in a loudspeaker.

FIG. 14A is a plan (top) view of a suspension system configured for use in a loudspeaker in accordance with examples of the disclosed technology.

FIGS. 14B and 14C are isometric and side views, respectively, of the suspension system of FIG. 14A.

FIG. 14D is an enlarged view of a portion of FIG. 14B.

### DETAILED DESCRIPTION

### I. Overview

Embodiments described herein relate to suspension systems, which may be referred to as spiders, suspension elements, or speaker dampers, for use in playback devices comprising one or more transducers or loudspeakers. Further embodiments relate to frames for use in loudspeakers and to loudspeakers including the suspension systems and/or frames.

Generally, the aspects described herein provide improvements over other suspension systems, such as spiders and speaker dampers, and loudspeakers. Particular improvements relate to one or more of: use of space within a loudspeaker, because the suspension systems described may be suited for more compact arrangements; improved operation of the suspension systems and loudspeakers, because the suspension systems and arrangements described may provide altered resonance characteristics; and to improved assembly of loudspeakers, because the suspension systems may have features that make assembly more straightforward. The suspension systems and loudspeakers may be particularly suitable for use in arrangements having a diaphragm driven by two or more driver arrangements, and to arrangements having two diaphragms that are arranged coaxially and/or on opposing faces of a frame of the loudspeaker frame.

A suspension system may be provided in a loudspeaker as a suspension system for one or more voice coils of the loudspeaker. The suspension system may provide damping of the coil. The suspension system may act as a restorative spring mechanism to return the voice coil to a rest position relative to a magnetic element. The suspension system may therefore provide a function of anchoring a voice coil within a loudspeaker to prevent excessive oscillation of the voice coil. In addition to the suspension system(s), a loudspeaker may include a flexible surround that provides a similar function to the suspension system but connects the diaphragm to the frame rather than the voice coil.

In some aspects described herein, a suspension system for use in a loudspeaker may include a coil holder, for coupling to a voice coil of a loudspeaker, and a flat spring, for coupling the coil holder to a frame of the loudspeaker. In some examples, the suspension system may include two flat springs. A flat spring may be a substantially planar, or flat, element which stores energy when deformed out of its plane.

One or more features may be provided to change resonance characteristics of the suspension system. For example, a stiffening element may be associated with the flat spring. The flat spring may have a resonance frequency. The stiffening element may change the resonance frequency of the flat spring. The stiffening element may stiffen the flat spring. Stiffening the flat spring may increase the resonance frequency of the flat spring. This may ensure that the resonance frequency is higher than a frequency at which the voice coil, and therefore the suspension system, may oscillate in use. The flat spring may be attached to the coil holder at a first end and to the frame at a second end. The stiffening element may be positioned closer to the second end than the first end. The stiffening element may also, alternatively or additionally be positioned closer to the frame than the coil holder. Positioning the stiffening element closer to the second end and/or closer to the frame may provide the effect of stiffening the flat spring while minimizing increases in mass to be moved by the voice coil. The stiffening element may be integrally formed with the flat spring. The stiffening element may be mounted on the flat spring. The stiffening element may comprise a member connected to the flat spring by at least two legs, such as one at either end of the bar. One of the legs may be provided at the second end of the flat spring.

More than one flat spring may be attached, coupled or connected to the coil holder, for example at least two flat springs may be attached to the coil holder. The at least two flat springs may be offset relative to one another. One way in which the flat springs may be offset is about the coil holder, such as at different positions around a perimeter or circumference of the coil holder. The flat springs may be offset about an axis of movement of the voice coil and suspension system. In other words, the flat springs may be radially offset. Radially offset flat springs may be connected to the frame at more than one position. Such an arrangement may ensure more stability in the movement of the suspension system. More than one flat spring may reduce twisting movement or movement other than movement along the axis of oscillation of the voice coil. Alternatively, or additionally, the flat springs may be ‘stacked’ such that two or more flat springs are connected to the coil holder so that they are spaced axially in a direction of movement of the voice coil. In some examples, a plurality of flat springs are connected to the coil holder at a first end, and the first ends of at least two of the plurality of flat springs are axially aligned. In some examples, all of the flat springs may have substantially the same shape.

One flat spring may overlay another flat spring. In some examples, an outer edge of one flat spring may have substantially the same shape as an inner edge of another flat spring. In doing so, overlay of the flat springs may be avoided. Avoiding overlay of the flat springs may improve manufacture by making techniques, such as injection moulding, simpler.

Where there are at least two flat springs which are axially offset in a direction of movement of the voice coil, the flat springs may be connected by one or more stiffening elements. The second ends of the flat springs may be connected by a stiffening element. The flat springs may be connected by a stiffening element between the first and second ends. Having more than one flat spring that are connected together generally increases the stiffness of the flat springs, thereby increasing the resonance frequency.

In some examples, the flat spring may delimit one or more through-holes. A plurality of through-holes may be delimited by the flat spring. A through-hole may be delimited in a direction perpendicular to a plane of the flat spring. The one or more through-holes may be delimited along the length of the flat spring. The one or more through-holes may have an oblong shape. The one or more through-holes may follow a contour of the flat spring. Providing one or more through-holes may reduce mass of the flat springs, which in turn may increase the resonance frequency. The one or more through-holes may cause the flat springs to be more compliant. The one or more through-holes may therefore enable tuning of the characteristics of the flat spring.

In some examples, the suspension system is mechanically connected, coupled or attached to the voice coil, when the suspension system is part of a loudspeaker. The suspension system may be mechanically connected to the voice coil by the coil holder. The coil holder may be mechanically connected to the voice coil in at least one direction. The coil holder may be mechanically connected to the voice coil in two opposing directions. The coil holder may be mechanically connected to the voice coil in the two opposing directions of movement of the voice coil when it oscillates in use. To mechanically connect the coil holder to the voice coil, a mechanical coupling may be provided on the coil holder. The mechanical coupling may include one or more flanges. In some examples, at least two flanges are provided. The voice coil may be positioned adjacent the flanges, such as between the flanges. In positioning the voice coil between the flanges, the coil holder may be moved with the voice coil by the voice coil pushing against a first flange in one direction and against a second flange in the opposite direction. The flanges may extend from a support or surround of the coil holder. The flanges may be radially offset from one another relative to the axis of movement of the voice coil. A plurality of flanges may be provided along an edge of a support of the coil holder. The flanges may be spaced apart. Spacing flanges apart may provide a benefit in cooling the coil. In some examples, the coil holder may partially surround a perimeter of the voice coil. This may also provide improvements in cooling as well as in how compact the suspension system is. A partially-surrounding coil holder also enables the voice coil to be received against the coil holder in a first direction that is perpendicular to a second direction in which the voice coil moves, in use. Such a partially-surrounding coil holder may have a circumference or perimeter which extends less than 180° about an axis parallel to the second direction, for example. This may improve manufacture.

The flat spring may be arranged to avoid interference with a frame of the loudspeaker, which may allow for a more compact loudspeaker arrangement. For example, in one example, the flat spring may be coupled to the coil holder in a different plane to the plane in which the flat spring extends. The flat spring may therefore be axially offset from the point at which it connects to the coil holder. This may be achieved using a connecting member, such as an angled or ramped element that changes the position of the flat spring relative to the coil holder.

The suspension system may be formed by injection moulding. In some examples, at least a portion of the suspension system may be integrally formed with a frame of the loudspeaker. The suspension system may be integrally formed with the frame by injection moulding. Integrally forming the suspension system with the frame may provide improved durability and reduce manufacturing complexity.

The suspension system may include a portion, element, holder, receptacle or other fixing for holding an electrical lead of the loudspeaker. Electrical leads are often left loose to accommodate the movement of the voice coil in use. In compact arrangements, loose electrical leads may be more likely to vibrate against a surface, so including a portion for holding the electrical lead on the suspension system reduces this likelihood without overly restricting the ability to accommodate the movement of the voice coil in use. A holder for an electrical lead on a suspension system allows the lead to move with the suspension system, reducing the possibility that it may get caught in the suspension system during movement. The portion may comprise a generally U-shaped bracket. The electrical lead may be pressed into the portion to fix it to the suspension system, and be held in position by the compliance or resilience of the material forming the U-shaped bracket. The portion may be provided on the coil holder of the suspension system.

The suspension system may be provided as part of a loudspeaker. A loudspeaker may comprise a frame, a first diaphragm flexibly or resiliently attached or mounted in the frame, a first motor, which may referred to as a speaker driver, for driving the first diaphragm, the first motor comprising a first magnetic element and a first voice coil, and a first suspension system as described above for coupling the first voice coil to the frame. In some examples, the first diaphragm may additionally be driven by a second motor, comprising a second magnetic element and a second voice coil, and the loudspeaker may comprise the second motor and a second suspension system. The first and second suspension systems may be connected by one or more connecting members. The connecting members may comprise stiffening ribs. The connecting members may transmit movement of the first and second voice coils to the diaphragm. One or both of the first and second suspension systems may include a reinforcing element coupled to the connecting members. The reinforcing element may reduce twisting or torsion of the connecting members, thereby improving the stability of the first and second suspension systems.

In other examples, the loudspeaker may include a second diaphragm. The second diaphragm may be coaxial with and/or opposed to the first diaphragm. The second diaphragm may be driven by at least a third motor, having a third magnetic element and third voice coil. A third suspension system as described above may couple the third voice coil to the frame. The second diaphragm may also be additionally driven by a fourth motor, in the same as discussed above for the first and second motors of the first diaphragm.

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

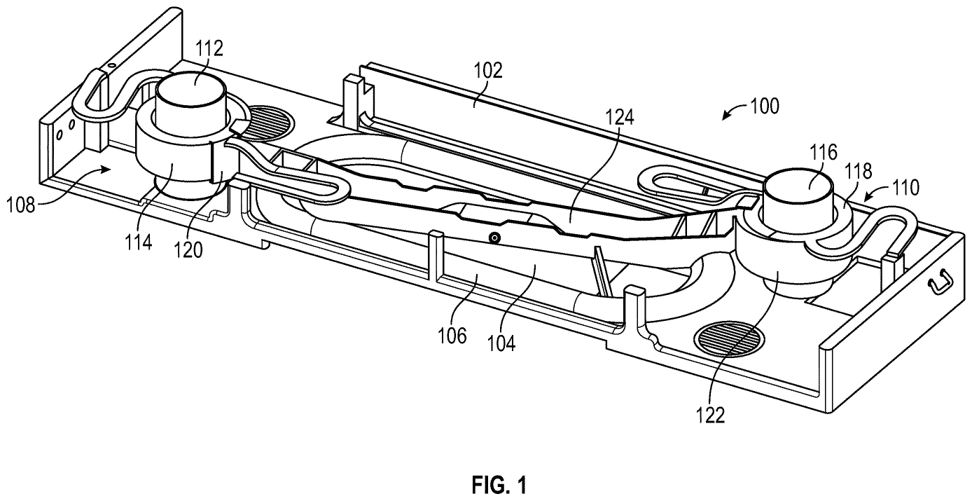

In the Figures, identical reference numbers identify generally similar, and/or identical, elements. To facilitate the discussion of any particular element, the most significant digit or digits of a reference number refers to the Figure in which that element is first introduced. For example, suspension system 120 is first introduced and discussed with reference to FIG. 1. Many of the details, dimensions, angles and other features shown in the Figures are merely illustrative of particular embodiments of the disclosed technology. Accordingly, other embodiments can have other details, dimensions, angles and features without departing from the spirit or scope of the disclosure. In addition, those of ordinary skill in the art will appreciate that further embodiments of the various disclosed technologies can be practiced without several of the details described below.

### II. Example Systems and Devices

FIG. 1 shows a perspective cutaway view of part of a transducer or a loudspeaker 100. In some examples, the loudspeaker 100 is at least partially housed in and/or on a playback device. The playback device, in some examples, may comprise one offered for sale by SONOS INC. including, for instance, a “SONOS ONE,” “FIVE,” “PLAYBAR,” “AMP,” “CONNECT: AMP,” “PLAYBASE,” “BEAM,” “ARC,” “CONNECT,” “MOVE,” “ROAM” “SUB,” or “SUB MINI.” Any other suitable playback devices may additionally or alternatively be used to implement the playback device(s) of example embodiments disclosed herein. In certain examples, the loudspeaker 100 may be configured to be positioned and/or operated in a vehicle, such as, for instance, an automobile, bus, train, airplane, boat, etc.

In the example of FIG. 1, the loudspeaker 100 includes a frame 102 having a diaphragm 104 mounted therein. The diaphragm 104 is resiliently attached and/or flexibly connected to the frame 102 by a surround 106. The loudspeaker 100 also includes a first motor 108 and a second motor. The first motor 108 includes a first magnetic element 112 and a first voice coil 114. The second motor 110 includes a second magnetic element 116 and a second voice coil 118. A first suspension system 120 is coupled to the first voice coil 114. The first suspension system 120 couples the first voice coil 114 to the frame 102. A second suspension system 122 is coupled to the second voice coil 118. The second suspension system 122 couples the second voice coil 118 to the frame 102. The first and second suspension systems may be referred to as spiders or as speaker dampers.

The first and second suspension systems 120, 122 are connected by two connecting elements 124, which may themselves be at least partially connected along their length or integrally formed. The connecting elements 124 also connect the first and second suspension systems 120, 122 to the diaphragm 104. In use, a signal is provided to the first and second voice coils 114, 118 causing them to move along their respective central axes. The first and second suspension systems 120, 122 move correspondingly with the voice coils 114, 118. This movement is transmitted to the diaphragm 104 via the connecting elements 124. By transmitting movement of the voice coils 114, 118 to the diaphragm 104, audio may be reproduced by the loudspeaker.

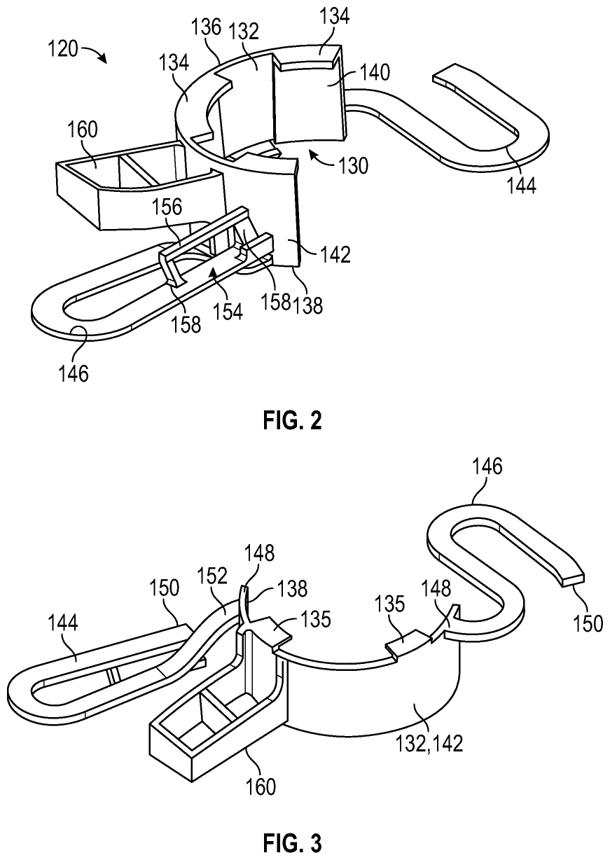

Turning now to FIGS. 2 to 4, an exemplary suspension system 120 is depicted in isolation of the other components depicted in FIG. 1. Although the exemplary suspension system is referred to using the reference numeral of the first suspension system 120, the features described in relation to the suspension system 120 may also be present in the second suspension system 122.

The suspension system 120 includes a coil holder 130. The coil holder has a support 132 and a plurality of flanges 134. The support 132 is configured to partially surround an outer surface of the voice coil 114. In this example, the support 132 is generally C-shaped, or in the form of an annulus sector, because the voice coil 114 is cylindrical. In other examples, the support may have a different shape to partially surround an outer surface of a voice coil. For example, a voice coil may have a square profile, and the support of the coil holder may be flat to partially surround one side of the voice coil, two sides at right angles to one another to partially surround two sides of the voice coil, or three sides that partially cover three sides of the voice coil.

As part of the loudspeaker in FIG. 1, the coil holder 130 is mechanically connected to the voice coil 114 for axial movement of the voice coil. The mechanical connection is preferably in two directions, which are the two directions in which the voice coil 114 moves along its central axis. Flanges 134 provide such mechanical coupling between the voice coil holder 130. In other examples, mechanical coupling between the voice coil and coil holder may be in at least one direction. In some examples, adhesive or another fixing means may be used to couple the voice coil and the coil holder. Adhesive may also be combined with a mechanical coupling, such as to retain the voice coil in the coil holder.

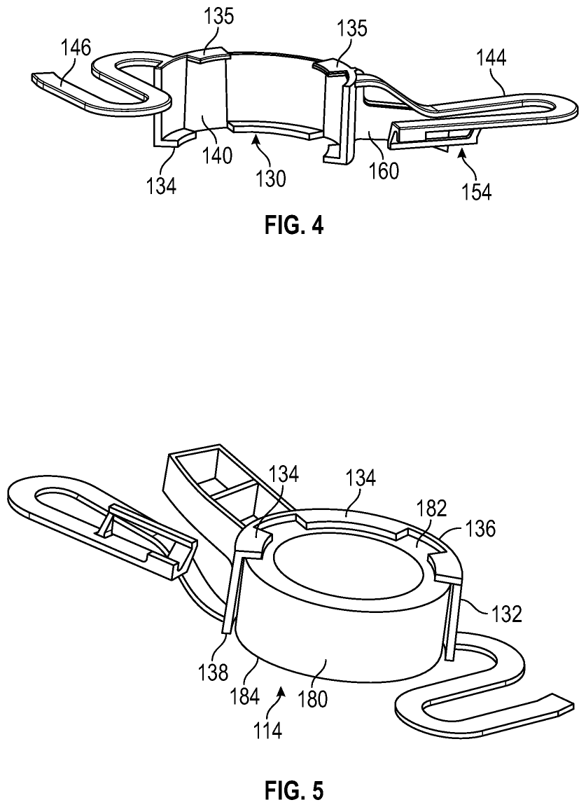

The flanges 134 extend from proximal and distal edges 136, 138 of the support 132. The proximal and distal edges 136, 138 may be defined relative to diaphragm 104 in an assembled loudspeaker, such that the proximal edge 136 faces or is closer to the diaphragm 104. As part of the loudspeaker, the voice coil 114 is received between the flanges 134 of each edge 136, 138. The flanges 134 along the proximal edge 136 couple the suspension system and the voice coil in one direction, while the flanges 135 along the distal edge 138 couple the suspension system and voice coil in the opposite direction. The flanges 134,135 extend from the support 132, and are arranged to cover part of a proximal or distal surface of the voice coil, when the coil is received between the flanges 134, 135. The flanges 134, 135, 135 are spaced apart from one another along the proximal and distal edges 136, 138. Spacing the flanges 134 apart from one another along their respective edges 136, 138 may provide a thermal benefit because less of the voice coil 114 is covered by the suspension system. Spacing the flanges 134, 135 also reduces the mass of the suspension system while still providing mechanical coupling. As can be best seen in FIG. 4, the flanges 134, 135 may also be offset or misaligned along the respective proximal and distal edges 136, 138. Offset flanges may be useful for improving stability of the voice coil whilst reducing mass of the suspension system.

FIG. 5 illustrates the suspension system 120 with the voice coil 114 in isolation of the other components of FIG. 1. As can be seen in FIG. 5, the support 132 partially surrounds the outer surface 180 of the voice coil 114, having an angular extent of about 180° about an axis of the voice coil, although other examples may have different angular extents. The flanges 134 along the proximal edge 136 extend over a proximal surface 182 of the voice coil 114. Although not visible in FIG. 5, the flanges 135 along the distal edge 138 of the support 132 extend over a distal surface 184 of the voice coil 114. The voice coil 114 is received between the flanges 134, 135.

The voice coil 114 is annular in shape and surrounds a central axis along which it oscillates in use. During assembly, the voice coil 114 may be received in a first direction between the flanges 134 that is perpendicular to the central axis and therefore the direction in which the voice coil 114 oscillates, in use. It may then be secured within the coil holder by an adhesive.

Returning to FIGS. 2 to 4, an inner surface 140 of the support 132 faces an outer surface of the voice coil 114. Connected to an outer surface 142 of the support 132 are a first flat spring 144 and a second flat spring 146. The flat springs 144, 146 couple the coil holder 130 to the frame 102 of the loudspeaker. The flat springs 144, 146 are coupled to the coil holder 130 at a first end 148 and are coupled to the frame 102 at a second end 150. When the loudspeaker is unassembled and the suspension system is unconnected to the frame or voice coil, the second ends 150 of the flat springs 144, 146 are free ends. The flat springs 144, 146 are radially offset about the coil holder 130. The radial offset may also be considered to be relative to an axis of movement of the voice coil, and therefore the suspension system, in use. The flat springs 144, 146 are connected to the coil holder at the distal edge 138, which is furthest from the diaphragm 104 in use.

A portion 152 couples the first flat spring 144 to the coil holder 130. The portion 152 is shaped to displace the first flat spring 144 relative to the distal edge 138 of the coil holder 130. The first flat spring 144 therefore extends in a plane that is different to the plane at which it is coupled to the coil holder. Such portions may be used for any flat springs of such a suspension system. These portions allow the suspension system to conform to the shaping or moulding (molding) of the frame 102, which may allow for a more compact loudspeaker.

A stiffening element 154 is associated with the first flat spring 144. The stiffening element 154 is positioned at the second end 150 of the first flat spring 144. The stiffening element 154 comprises member 156 that connects to the first flat spring 144 through two legs 158 at either end. The stiffening element 154 stiffens the first flat spring 144 to increase the resonance frequency of the flat spring 144. Mounting the stiffening element 154 at the second end 150 raises the stiffness of the flat spring 144 without significantly altering the mass being moved by the voice coil 114 in use. The stiffening element 154 is provided on and stiffens a portion of the first flat spring 144 rather than the entire length of the first flat spring 144. Stiffening a portion of the first flat spring may allow for tuning of the stiffness to change the resonance. Providing a stiffening element on the first flat spring rather than increasing the thickness of the first flat spring allows stiffness to be added to the first flat spring without affecting other properties of the first flat spring, such as fatigue limits.

The suspension system 120 also includes a reinforcing element 160 connected to the coil holder 130 at its outer surface 142. As shown in FIG. 1, the reinforcing element 160 is connected to the connecting elements 124. The reinforcing element 160 may strengthen the connecting elements 124. The reinforcing element 160 may strengthen the suspension system 120. The reinforcing element 160 may strengthen the connection between the suspension system 120 and the connecting elements 124. The reinforcing element 160 may reduce twisting and/or movement by the suspension system other than, for instance, the linear movement imparted to it by the voice coil.

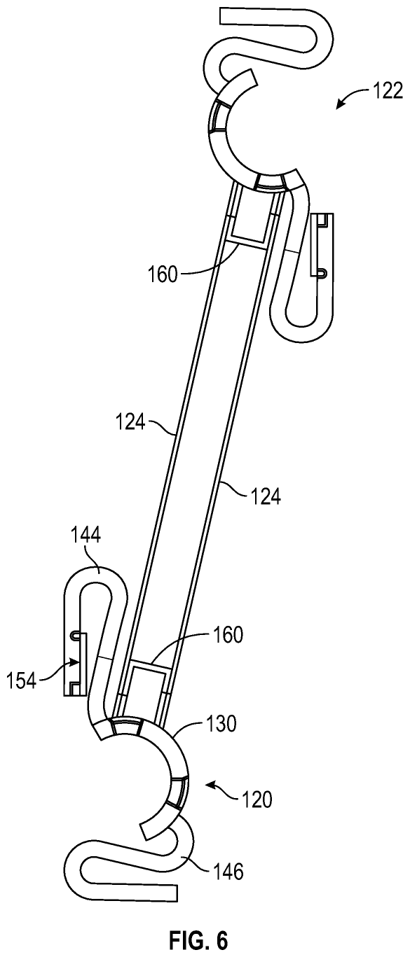

FIG. 6 illustrates the connection between two suspension systems 120, 122 and the connecting elements 124 using reinforcing elements 160 in isolation of the other components of FIG. 1. As can be seen, the reinforcing elements 160 have a box form that corresponds to a space between the connecting elements 124. The connecting elements 124 are therefore connected to the suspension system 120 over a greater surface area than if they were otherwise attached, reducing torsional forces and improving the stiffness and connection of both elements.

Considering FIGS. 2 to 6, although the parts of the suspension system 120 are described separately, this is for the purpose of clarity. In general, the suspension system 120 may be a single part, i.e. the components are integrally formed. To achieve this, the suspension system 120 may be moulded (molded), cast, or formed. For example, the suspension system 120 may be injection moulded. The suspension system 120 may be formed from a plastics material such as PEEK, Nylon, or Acetal (also known as POM or Polyoxymethylene). In other example, a portion of the suspension system may be injection moulded or otherwise integrally formed. Two or more portions of the suspension system may be joined together using adhesive or fixes or joined in any suitable way.

The suspension systems may be for use in any size of loudspeaker or playback device incorporating such a loudspeaker, such as headphones or earbuds, tweeters, woofers, or subwoofers. In some examples, a suspension system may have dimensions such that it fits in a bounding box ranging from 24 mm by 9 mm to 64 mm by 38 mm.

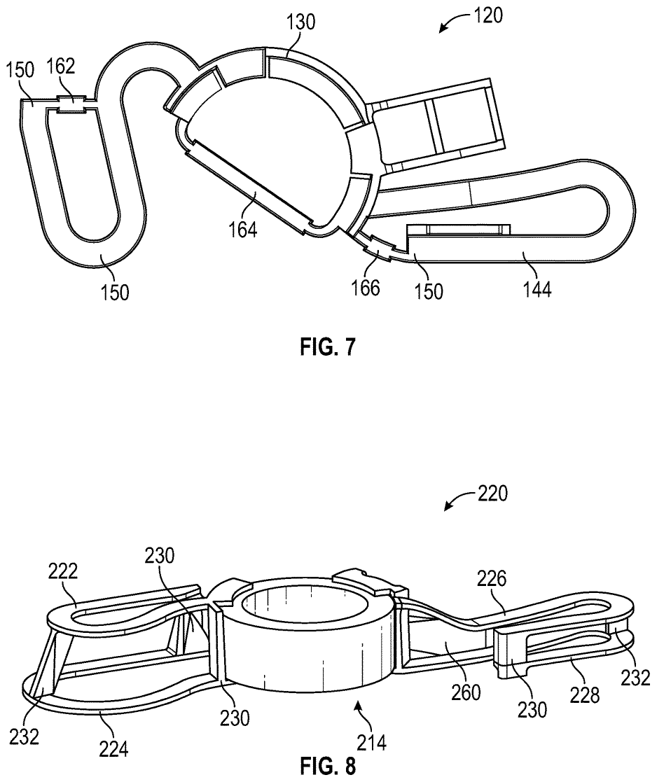

Support structures may also be included during the process to increase the stiffness of the suspension system 120 during assembly of the speaker. This may simplify the assembly of a loudspeaker including the suspension system. An example of this is shown in FIG. 7. In FIG. 7, the suspension system 120 includes three support structures 162, 164, and 166. A first support structure 162 connects the second, free end of the second flat spring 146 to another part of the second flat spring 146. The second support structure 164 connects two flanges 134 of the coil holder 130. The third support structure 166 connects the second, free end of the first flat spring 144 to the coil holder 130. The support structures 162, 164, 166 therefore reinforce parts of the suspension system 120 that may flex or be subjected to forces during assembly. This improves the rigidity of the suspension system 120 during assembly. The support structures 162, 164, 166 may be removed after the suspension system has been positioned as part of the loudspeaker. For example, the support structures may be removed by hand or by an automated production line. The support structures may be removed at different points in assembly, for example support 164 may be removed before supports 162 and 166 to allow the voice coil to be inserted. Supports 162 and 166 may then be removed after the voice coil is in place. It will also be appreciated that support structures may be provided at other positions than those shown in FIG. 7.

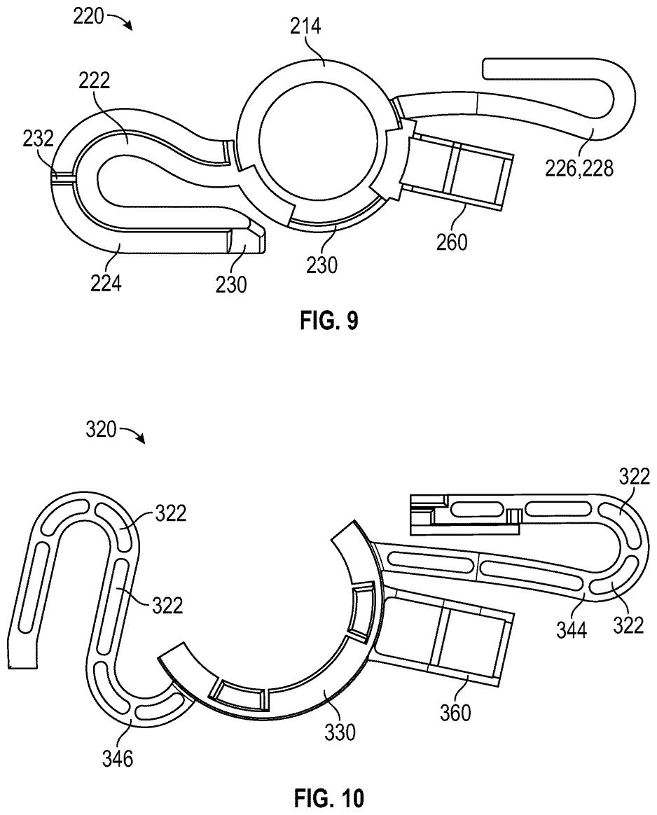

FIGS. 8 and 9 show a voice coil 214 and a further suspension system 220 that may be used in a transducer or loudspeaker such as loudspeaker 100. The suspension system 220 shown in FIGS. 8 and 9 has a coil holder 230 and a reinforcing element 260 that are similar to those of the suspension system 120 described above in relation to FIGS. 2 to 7. Suspension system 220 differs from the suspension system 120 of FIGS. 2 to 7 because it includes a first pair of ‘stacked’ flat springs 222, 224 and a second pair of stacked flat springs 226, 228. The first pair of flat springs 222, 224 are positioned on one side of the coil holder 230 and the second pair of flat springs 226, 228 are positioned on the other, generally opposite, side of the coil holder 230, radially or circumferentially offset from the first pair of flat springs 222, 224. The flat springs on each side are stacked, so that one flat spring is positioned above the other when viewed in plan. Stacking the flat springs in this way may be referred to as the flat springs of each pair being axially spaced in a direction of movement of the voice coil. In each pair, one flat spring is coupled to the coil holder 230 at a proximal edge of the coil holder while the other flat spring is coupled to the coil holder 230 at a distal edge of the coil holder. In other arrangements, the flat springs may be connected to the coil holder 230 at any position.

In the arrangement shown in FIGS. 8 and 9, the flat springs of each pair are connected by two stiffening elements 230, 232. A first stiffening element 230 connects the free ends 234 of the flat springs together. A second stiffening element 232 connects the flat springs together at a substantially central position along the length of the flat spring.

As can be best seen in FIG. 9, when viewed in plan the first pair of flat springs 222, 224 are not aligned. Instead, an inner edge of one flat spring is aligned and has the same shape as an outer edge of the other flat spring. This may be referred to as tapering. Arranging the flat springs in this way may assist manufacture, because tapered shapes may be better suited to moulding or casting due to the ease with which they can be removed from the mould (mold) or cast. In other examples, the flat springs may have the same profile or edge shapes and be aligned in the axial direction of the voice coil, as is illustrated in FIGS. 8 and 9 by the second pair of flat springs 226, 228.

FIG. 10 shows a further suspension system 320. The suspension system 320 and the suspension system 120 are substantially similar. Suspension system 320 and suspension system 120 differ because the flat springs delimit a plurality of through-holes 322. The through-holes 322 are delimited by the flat springs 344, 346. The through-holes 322 have a generally oblong, rectangular or stadium shape, and are positioned along the length of the flat springs 344, 346. Delimiting through-holes in the flat springs 344, 346 may reduce a mass of the flat springs 344, 346. Delimiting through-holes may also increase the compliance of the flat springs 344, 346. Reducing mass and increasing compliance may be useful in tuning the properties of the flat springs 344, 346 to the requirements of particular loudspeakers. The flat springs may be combined with any of the other features also described here, such as stiffening elements attached to the flat spring as discussed with reference to element 154, support structures to assist assembly as discussed with reference to FIG. 7, and “stacked” flat springs of FIGS. 8 and 9.

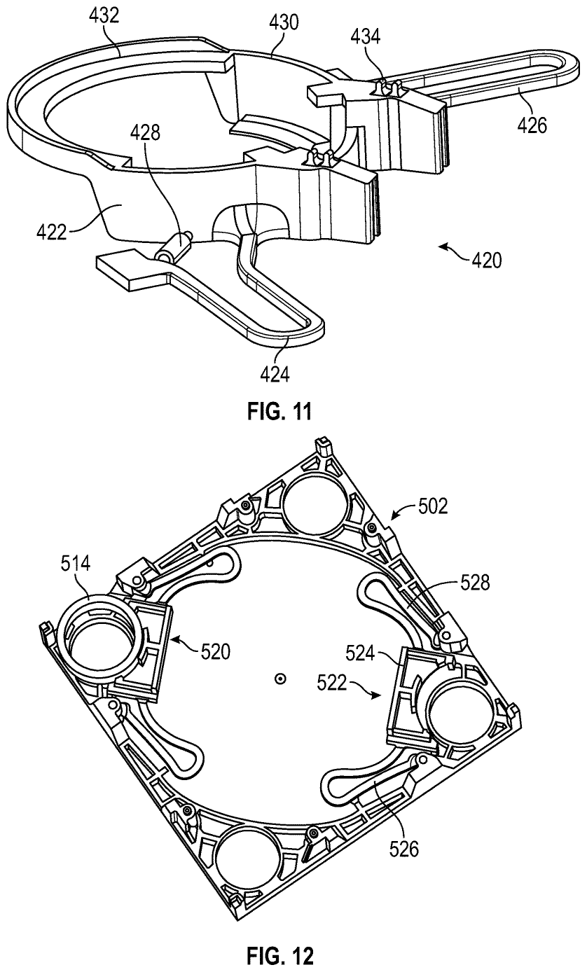

FIG. 11 shows an example of a further suspension system 420. The further suspension system 420 has a coil holder 422 and two flat springs 424, 426. The suspension system 420 is shown in FIG. 11 with support structures 428 used to maintain stiffness during assembly and which may be removed after assembly. The suspension system 420 may include any of the features described in relation to the suspension systems of FIGS. 2 to 10 above.

The coil holder 422 includes a support 430 that partially surrounds an outer perimeter of the voice coil in use. The coil holder 422 also includes a semi-circular flange 432 that connects to the edges of the support 430. The semi-circular flange 432 may provide support and positioning functions for the voice coil in use as well as stiffening for the coil holder 422. The voice coil may still be received into the suspension system 420 by sliding it in the first direction perpendicular to the direction of movement in use.

The suspension system 420 of FIG. 11 includes portions 434 for holding an electrical lead. The portions 434 in this example comprise clips into which the electrical lead may be pressed. Holding the electrical lead against the suspension system 420 makes it less likely that the electrical lead will vibrate against or otherwise interfere with other components of the loudspeaker. The use of clips to retain the electrical lead thus may positively impact audio quality and durability. The portions 434 for holding the electrical lead are here provided on the coil holder. In other examples, the portions 434 may be positioned elsewhere on the suspension system 430. Although depicted in relation to the example suspension system 430 of FIG. 11, portions 434 for holding an electrical lead may be included as part of any suspension system described herein, in combination with any of the features of those suspension systems. Likewise, a coil holder with an additional semi-circular flange may be included in any of the suspension systems discussed above.

FIG. 12 shows part of a frame 502 for a loudspeaker. Two suspension systems 520 and 522 are integrally formed with the frame 502. A voice coil 514 is shown in relation to one of the suspension systems 520. The suspension systems 520, 522 each have a coil holder 524 and two flat springs 526, 528. In this example, the coil holder 524 does not incorporate flanges and instead holds the coil using adhesive.

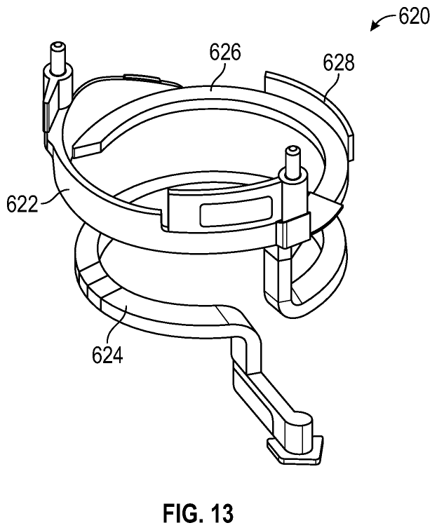

FIG. 13 shows a suspension system 620. The suspension system 620 includes a coil holder 622 and a circular flat spring 624. The coil holder includes a flange 626 that supports a distal surface of a voice coil and a support 628. In the suspension system of FIG. 13, the suspension system is inserted into the coil holder in the same direction that it moves in use and secured with adhesive.

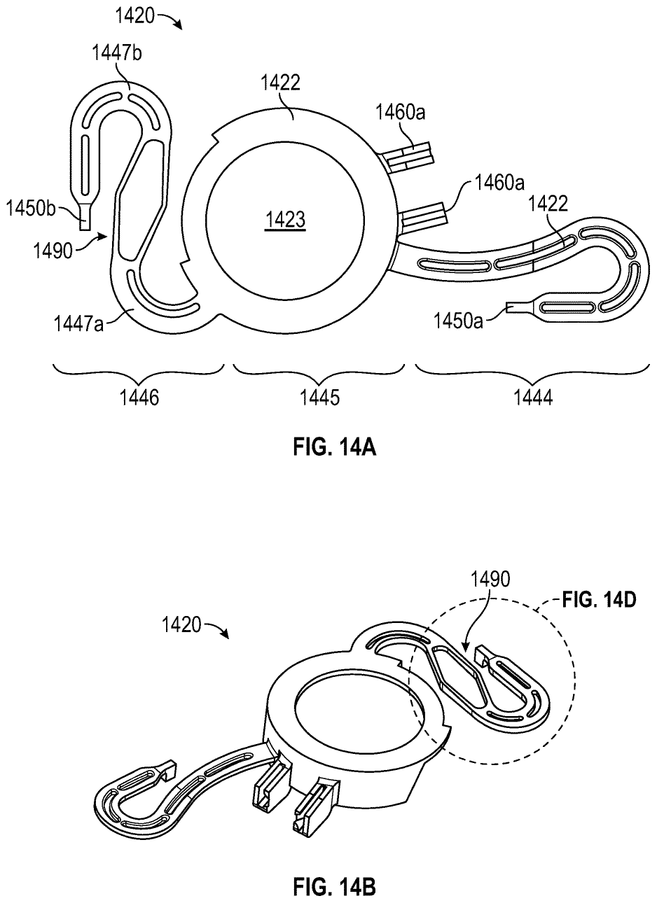

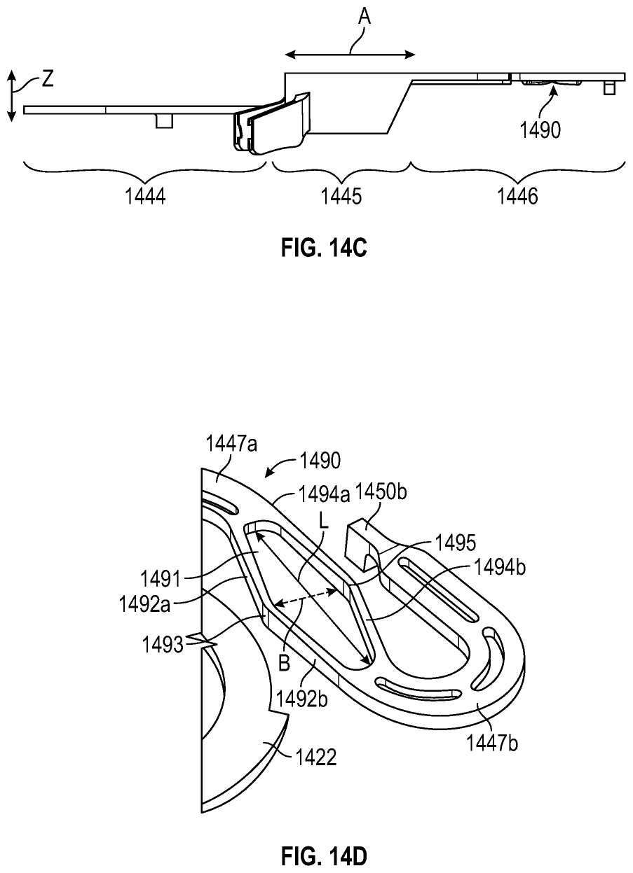

FIG. 14A is a plan (top) view of a suspension system 1420 similar to the suspension systems 120, 220, 320, 420, 520, and/or 620 described above. FIGS. 14B and 14C are isometric and side views, respectively, of the suspension system 1420. FIG. 14D is an enlarged view of a portion of FIG. 14B. Referring to FIG. 14A, the suspension system 1420 comprises a proximal portion 1444, an intermediate portion 1445, and a distal portion 1446. In some examples, the proximal portion 1444 and distal portion 1446 comprise individual flat springs (e.g., the flat springs 244 and 346 of FIG. 10). Ends 1450 (shown as a first end 1450a and a second end 1450b) are configured to couple the proximal portion 1444 and the distal portion 1446, respectively, to corresponding sites on a transducer frame (e.g., the frame 102 of FIG. 1) when the suspension system 1420 is installed in a transducer such as the loudspeaker 100 (FIG. 1). A movable compensating element 1490 is positioned between a first segment 1447a and a second segment 1447b of the distal portion 1446.

A voice coil holder 1422 in the intermediate portion 1445 defines an opening 1423 and is configured to receive a voice coil (not shown) such as the voice coil 114 (FIGS. 1 and 5). A reinforcing element 1460 (shown as a first reinforcing element 1460a and a second reinforcing element 1460b) connects to a corresponding portion of a connecting element (not shown) such as the connecting elements 124 (FIG. 1 and FIG. 6). One or more through-holes or voids 1422 (e.g., the through-holes 322 of FIG. 10) can reduce the mass and/or increase the compliance of the suspension system 1420. As described in more detail above with respect to FIG. 10, the amount, shape(s), and/or size(s) of the voids 1422 can facilitate tuning of the suspension system 1420 performance according to transducer design requirements.

Referring now to 14D, the compensating element 1490 (e.g., one or more elongating members, stress relief features, strain relief features, connectors, linkages, hinge assemblies, braces, springs, suspension elements, dampers, actuators) defines a hole, void, aperture, or opening 1491. A first suspension arm 1492 (shown as a first proximal arm portion 1492a and a first distal arm portion 1492b) and a second suspension arm 1494 (shown as a second proximal arm portion 1494a and a second distal arm portion 1494b). Flexible portions 1493, 1495 (e.g., one or more hinges, joints, bearings, pivots) allow the corresponding suspension arms 1492, 1494 to move inward and outward in a direction substantially aligned with axis B. The resulting inward motion (e.g., the flexible portions 1493 and 1495 move toward each other) and outward motion (e.g., the flexible portions 1493 and 1495 move away from each other) causes a length L of the compensating element 1490 to increase and decrease, respectively.

In the illustrated example, the suspension arms 1492, 1494 move substantially laterally (e.g., coplanar with the axis B) in response to movement of the first segment 1447a as the voice coil holder 1422 moves axially (e.g., in a direction aligned with axis Z of FIG. 14C). In some examples, however, the suspension arms 1492, 1494 move in a direction perpendicular (or oblique) to the axis B. For instance, the suspension arms 1492, 1494, rather than move inward and outward toward voice coil holder 1422 and the second end 1450b, respectively, may, in certain examples, be rotated 90 degrees such that they effectively move upward and downward (e.g., parallel to the movement of the voice coil holder 1422) during operation. Moreover, in the illustrated example the compensating element 1490 comprises a pair of suspension arms (e.g., suspension arms 1492, 1494). In some examples, the compensating element 1490 comprises a single suspension arm (e.g., such as a shock absorber). In some examples, the compensating element 1490 comprises a linkage with a scissor mechanism. In certain examples, the compensating element 1490 comprises a bellows.

Referring now to FIGS. 14A-14D together, during operation of a transducer (e.g., the loudspeaker 100 of FIG. 1), the individual suspension elements can experience significant forces and stresses as the voice coil(s) move the corresponding diaphragm (e.g., the diaphragm 104 of FIG. 1). In some cases, balances inherent in a particular arrangement or design of components can mitigate or at least reduce the stress in individual suspension elements. In many instances, however, stress or force imbalances in an individual suspension element can cause strain in the element, which could compromise performance and hasten failure. The stress may occur in several dimensions, such as a horizontal, lateral, or first direction (e.g., aligned with axis A of FIG. 14C) and/or a vertical or second direction (e.g., aligned with the axis Z of FIG. 14C).

In some examples, movement of the voice coil holder 1422 (caused by corresponding movement of a voice coil such as the voice coil 114 of FIG. 1) can cause the proximal portion 1444 to pull the the distal portion 1446 (or vice versa), thereby potentially introducing stress in the first and second segments 1447a and 1447b of the distal portion 1446. In examples omitting the compensating element 1490 (e.g., the flat spring 346 of FIG. 10), the stress may result in excessive strain that can degrade performance and ultimately cause failure. The compensating element 1490, however, can beneficially mitigate, or at least substantially reduce, an amount of stress in the distal portion 1446 during operation by changing its length to compensate for force imbalances in the suspension system 1490.

Patent applications WO 2018/056814 A1 (‘LOUDSPEAKER UNIT WITH MULTIPLE DRIVE UNITS’), WO 2019/086357 A1 (‘LOW PROFILE LOUDSPEAKER DEVICE’), WO 2022/029005 A1 (‘SPEAKER UNIT’), and WO 2022/096560 A1 (‘SPEAKER UNIT WITH A SPEAKER FRAME AND TWO OPPOSING SOUND PRODUCING MEMBRANES’), each of which are incorporated by reference for all purposes, describe examples of loudspeaker units with which the suspension systems described herein may be used. Other forms of loudspeaker may also be used with the techniques described herein.

### III. Conclusion

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways) to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

1. A loudspeaker comprising:
a frame;
a diaphragm flexibly attached to the frame;
a motor for driving the diaphragm, the motor comprising a magnetic element and a voice coil; and
a suspension system comprising:
a coil holder coupled to the voice coil,
a flat spring coupling the coil holder and the frame, and
a stiffening element associated with the flat spring, wherein the stiffening element is mounted on the flat spring.

2. The loudspeaker of claim 1, wherein:
the flat spring is attached to the coil holder at a first end and to the frame at a second end; and
the stiffening element is positioned closer to the second end than the first end.

3. The loudspeaker of claim 1, wherein the flat spring is a first flat spring and the suspension system comprises a second flat spring coupling the coil holder and the frame.

4. The loudspeaker of claim 3, wherein the second flat spring is axially spaced from the first flat spring in a direction of movement of the voice coil.

5. The loudspeaker of claim 4, wherein:
the flat spring and the second flat spring are connected by the stiffening element.

6. The loudspeaker of claim 19, wherein:
the flat spring is attached to the coil holder at a first end and to the frame at a second end; and
the compensating element is positioned closer to the first end than the second end.

7. The loudspeaker of claim 3, wherein the second flat spring is radially offset from the flat spring about an axis of movement of the voice coil.

8. The loudspeaker of claim 1, wherein the flat spring delimits at least one through-hole.

9. The loudspeaker of claim 1, wherein the coil holder is mechanically connected to the voice coil in at least one direction.

10. The loudspeaker of claim 8, wherein the coil holder comprises a flange for engaging the voice coil.

11. The loudspeaker of claim 10, comprising at least two flanges between which the voice coil is received.

12. The loudspeaker of claim 1, wherein the flat spring is coupled to the coil holder in a first plane and the flat spring extends in a second plane that is different to the first plane.

13. The loudspeaker of claim 1, wherein suspension system comprises a portion for holding an electrical lead.

14. The loudspeaker of claim 1, wherein the suspension system is integrally formed with the frame.

15. The loudspeaker of claim 1, comprising:
a further motor for driving the diaphragm, the further motor comprising a further magnetic element and a further voice coil; and
a further suspension system comprising:
a further coil holder coupled to the further voice coil;
a further flat spring coupling the further coil holder and the frame; and
a further stiffening element mounted on the further flat spring.

16. The loudspeaker of claim 15, further comprising at least one connecting member connecting the suspension system and the further suspension system, wherein at least one of the suspension system and the further suspension system comprises a reinforcing element coupled to the connecting member.

17. The loudspeaker of claim 16, wherein the at least one connecting member is configured to transmit movement of the voice coil and the further voice coil to the diaphragm.

18. The loudspeaker of claim 1, comprising:
an additional diaphragm flexibly attached to the frame coaxially with the diaphragm;
an additional motor for driving the additional diaphragm, the additional motor comprising an additional magnetic element and an additional voice coil; and
an additional suspension system comprising an additional coil holder coupled to the additional voice coil, an additional flat spring coupling the additional coil holder and the frame, and an additional stiffening element mounted on the additional flat spring.

19. The loudspeaker of claim 1, wherein the suspension system further comprises a compensating element associated with the flat spring.
